(19) United States
(12) Patent Application Publication
(10) Pub. No.: US 2007/0002248 A1
(43) Pub. Date: Jan. 4, 2007

(54) Liquid crystal display and panel therefor

(75) Inventors: Hak-Sun Chang, Yongin-si (KR); Hyun-Wuk Kim, Yongin-si (KR); Seung-Hoo Yoo, Seongnam-si (KR); Yoon-Sung Um, Yongin-si (KR); Hee-Wook Do, Suwon-si (KR)

Correspondence Address: F. CHAU & ASSOCIATES, LLC, 130 WOODBURY ROAD, WOODBURY, NY, 11797, US

(73) Assignee: Samsung Electronics Co., LTD.

(21) Appl. No.: 11/448,635

(22) Filed: Jun. 7, 2006

(30) Foreign Application Priority Data
Jun. 29, 2005 (KR) 10-2005-0056971

(51) Int. Cl. G02F 1/1343

(52) U.S. Cl. 349/141

(57) ABSTRACT

A liquid crystal display includes a first substrate, a plurality of first field-generating electrodes formed on the first substrate and having a first cutout, a second substrate facing the first substrate, and a plurality of second field-generating electrodes formed on the second substrate and having a second cutout. A liquid crystal display further includes a liquid crystal layer formed between the first and second substrates, wherein the second field-generating electrode is thicker than the first field-generating electrode, and a width of the first cutout is narrower than a width of the second cutout.

This application claims priority from Korean Patent Application number 10-2005-0056971 filed on Jun. 29, 2005, and all the benefits accruing therefrom under 35 U.S.C. §119, the disclosure of which is incorporated by reference herein in its entirety.

### BACKGROUND OF THE INVENTION

(a) Field of the Invention

The present invention relates to a liquid crystal display and a panel thereof.

(b) Description of Related Art

A liquid crystal display (LCD) is one of the most widely used flat panel displays. An LCD includes two panels including field-generating electrodes such as pixel electrodes and common electrodes, and a liquid crystal (LC) layer interposed there between. The LCD displays images by applying voltages to the field-generating electrodes to generate an electric field in the LC layer, which controls orientations of LC molecules in the LC layer to adjust polarization of incident light.

Among the LCDs, a vertical alignment (VA) mode LCD, which aligns LC molecules such that the long axes of the LC molecules are perpendicular to the panels in the absence of an electric field, achieves a high contrast ratio and a wide reference viewing angle. At the wide reference viewing angle, the contrast ratio is equal to about 1:10 of a normal angle. The wide reference viewing angle may be a limit angle for the inversion in luminance between the grays.

The wide viewing angle of the VA mode LCD can be realized by cutouts in the field-generating electrodes and protrusions on the field-generating electrodes. The cutouts and the protrusions can determine the tilt directions of the LC molecules. The tilt directions can be distributed in several directions by using the cutouts and the protrusions such that the reference viewing angle is widened.

However, although the controllability of the LC molecules may be improved by increasing the width of the cutouts or the protrusions to reinforce the horizontal ingredient of the fringe field, increasing the width of the cutouts or the protrusions may cause a decrease of the aperture ratio.

### SUMMARY OF THE INVENTION

According to an embodiment of the present invention, a liquid crystal display includes a first substrate, a plurality of first field-generating electrodes formed on the first substrate and having a first cutout, a second substrate facing the first substrate; a plurality of second field-generating electrodes formed on the second substrate and having a second cutout, and a liquid crystal layer formed between the first and second substrates, wherein the second field-generating electrodes are thicker than the first field-generating electrodes, and a width of the first cutout is in the range of about 50 to 90% of a width of the second cutout.

The thickness of the second field-generating electrode is about 1.5 to 3 times the thickness of the first field-generating electrode.

It is preferable that the first and second cutouts are alternately arranged.

The second cutout may have a notch.

The liquid crystal display may further include a plurality of gate lines and a plurality of data lines formed on the first substrate, and a plurality of thin film transistors electrically connected to the first field-generating electrode, the gate lines, and the data lines.

A thin film transistor may have a gate electrode electrically connected to the gate line, a gate insulating layer covering the gate electrode, a semiconductor formed on the gate insulating layer, and a source electrode and a drain electrode formed the semiconductor.

The liquid crystal display may further include a light-blocking member formed on the second insulating substrate.

The liquid crystal display may further include a plurality of color filters formed on the second insulating substrate.

According to an embodiment of the present invention, a liquid crystal display panel includes a first substrate, a gate line and a data line formed on the first substrate, a thin film transistor electrically connected to the gate line and the data line, and a pixel electrode electrically connected to the thin film transistor and having a first cutout. The liquid crystal display panel includes a second substrate facing the first substrate, a color filter formed on the second substrate, a common electrode formed on the second substrate and having a second cutout, and a liquid crystal formed between the first and second substrates, wherein a thickness of the common electrode is about 1.5 to 3 times a thickness of the pixel electrode, and a width of the first cutout is in the range of about 50 to 90% of a width of the second cutout.

It is preferable the first and second cutouts are alternately arranged.

The second cutout may have a notch.

According to an embodiment of the present invention, a liquid crystal display panel includes a first substrate, a gate line and a data line formed on the first substrate, a thin film transistor electrically connected to the gate line and the data line, a pixel electrode electrically connected to the thin film transistor and having a cutout. The liquid crystal display panel includes a second substrate facing the first substrate, a color filter formed on the second substrate, a common electrode formed on the second substrate, a protrusion formed on the common electrode, and liquid crystal formed between the first and second substrates, wherein the common electrode is thicker than the pixel electrode, and a width of the cutout is in the range of about 50 to 90% of a width of the protrusion cutout.

The thickness of the common electrode is about 1.5 to 3 times the thickness of the pixel electrode.

It is preferable that the cutout and the protrusion are alternately arranged.

It is preferable that the protrusion is made of an organic insulating material.

### BRIEF DESCRIPTION OF THE DRAWINGS

The present invention will become more apparent by describing embodiments thereof in detail with reference to the accompanying drawings, in which:

FIG. 1 is a layout view of a TFT array panel of an LCD according to an embodiment of the present invention;

FIG. 2 is a layout view of a common electrode panel of an LCD according to an embodiment of the present invention;

FIG. 3 is a layout view of an LCD including the TFT array panel shown in FIG. 1 and the common electrode panel shown in FIG. 2;

FIG. 4 is a sectional view of the LCD shown in FIG. 3 taken along the line IV-IV;

FIG. 5 is a sectional view of the LCD shown in FIG. 3 taken along the line V-V;

FIGS. 6A to 6G are views showing equipotential lines depending on the variety of widths of the cutouts in the LCDs according to an embodiment of the present invention;

FIG. 7 is a layout view of a TFT array panel for an LCD according to an embodiment of the present invention;

FIG. 8 is a layout view of a common electrode panel for an LCD according to an embodiment of the present invention;

FIG. 9 is a layout view of an LCD including the TFT array panel shown in FIG. 7 and the common electrode panel shown in FIG. 8;

FIG. 10 is a sectional view of the LCD shown in FIG. 9 taken along the line X-X;

FIG. 11 is a layout view of an LCD according to another embodiment of the present invention; and

FIGS. 12 and 13 are sectional views of the LCD shown in FIG. 11 taken along the lines XII-XII and XIII-XIII, respectively.

### DETAILED DESCRIPTION OF PREFERRED EMBODIMENTS

The present invention will now be described more fully hereinafter with reference to the accompanying drawings, in which preferred embodiments of the invention are shown. The present invention may, however, be embodied in many different forms and should not be construed as limited to embodiments set forth herein.

Liquid crystal displays and thin film transistor (TFT) array panels for LCDs according to embodiments of the present invention will be described with reference to the accompanying drawings.

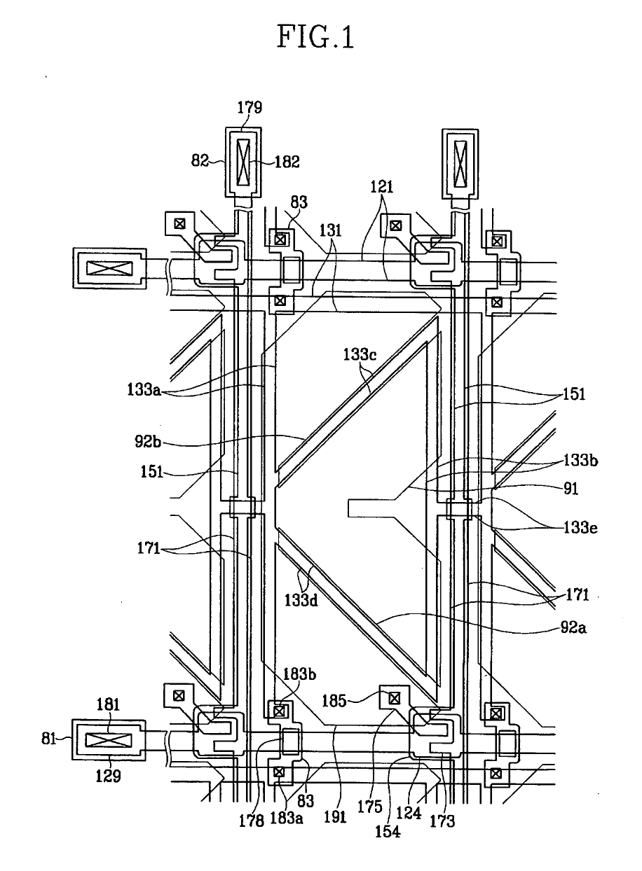

An LCD, according to an embodiment of the present invention, will be described in detail with reference to FIGS. 1 to 5.

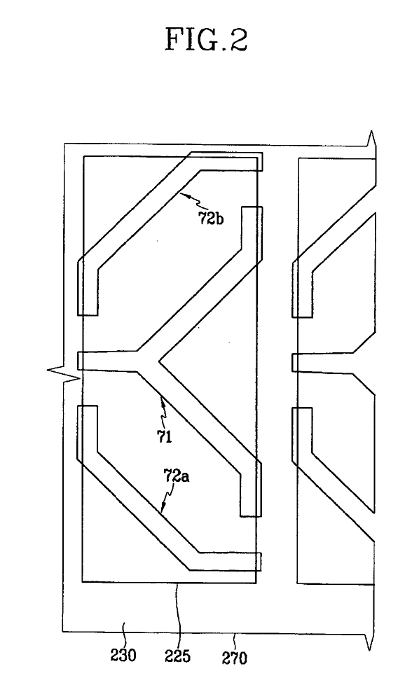

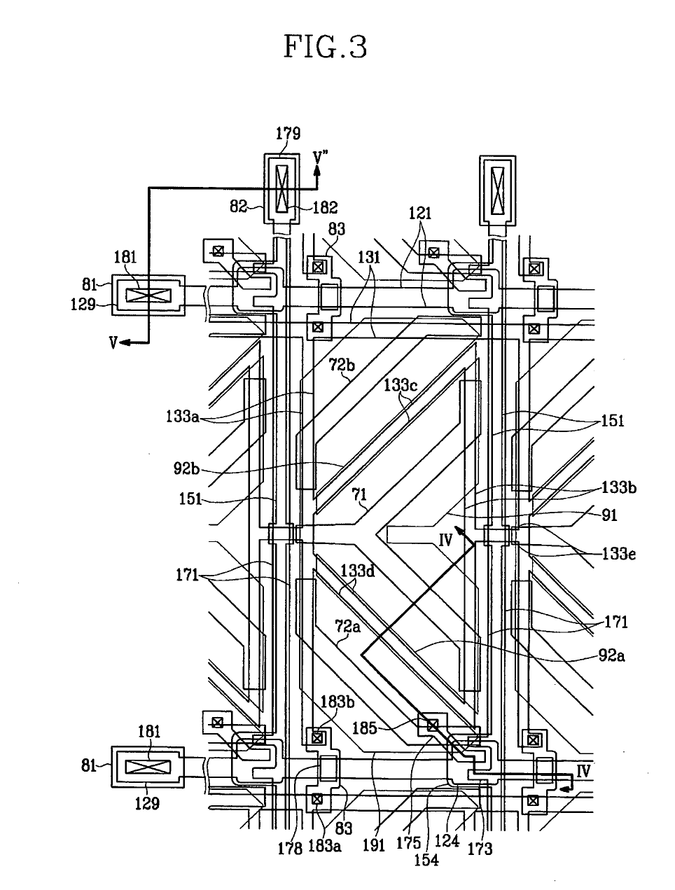

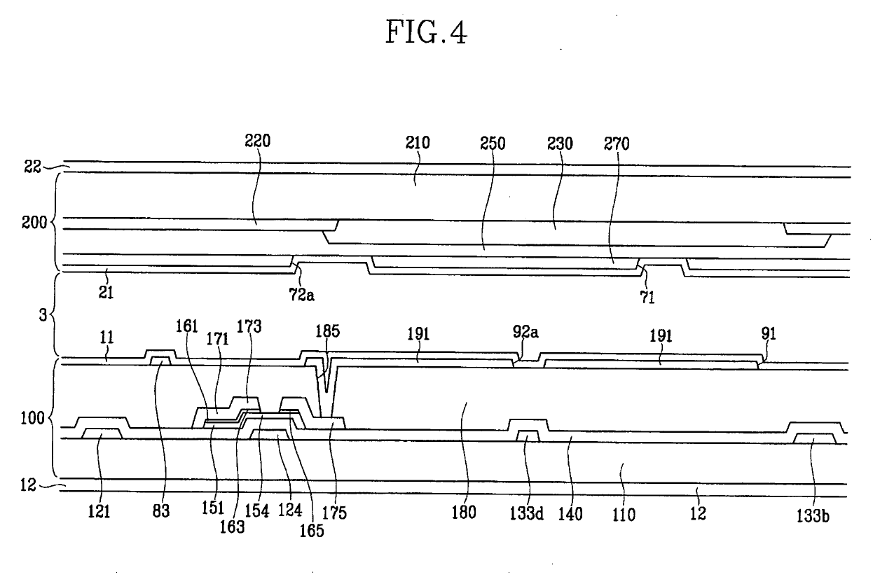

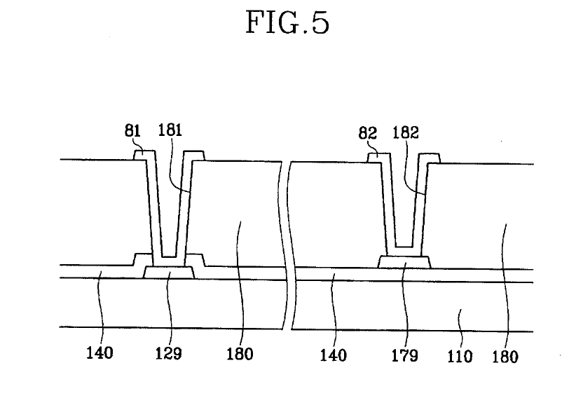

FIG. 1 is a layout view of a TFT array panel of an LCD according to an embodiment of the present invention, FIG. 2 is a layout view of a common electrode panel of an LCD according to an embodiment of the present invention, FIG. 3 is a layout view of an LCD including the TFT array panel shown in FIG. 1 and the common electrode panel shown in FIG. 2, FIG. 4 is a sectional view of the LCD shown in FIG. 3 taken along the line IV-IV, and FIG. 5 is a sectional view of the LCD shown in FIG. 3 taken along the line V-V.

An LCD according to an embodiment of the present invention includes a TFT array panel 100, a common electrode panel 200, and an LC layer 3 interposed between the panels 100 and 200.

The TFT array panel 100 is now described in detail with reference FIGS. 1, 3, 4, and 5.

A plurality of gate lines 121 and a plurality of storage electrode lines 131 are formed on an insulating substrate 110 such as transparent glass.

The gate lines 121 extend substantially in a transverse direction, separated from each other, and transmit gate signals. Each gate line 121 includes a plurality of projections forming a plurality of gate electrodes 124 and an end portion 129 having an area for contact with another layer or an external driving circuit. A gate driving circuit (not shown) for generating the gate signals may be mounted on a flexible printed circuit (FPC) film (not shown), which may be attached to the substrate 110, directly mounted on the substrate 110, or integrated into the substrate 110. The gate lines 121 may extend to be connected to a driving circuit integrated on the substrate 110.

Each of storage electrode lines 131 extends substantially in the transverse direction, disposed between two adjacent gate lines 121 and closer to an upper one of the two adjacent gate lines 121. Each storage electrode line 131 includes a plurality of sets of branches 133a to 133d and a plurality of connections 133e connecting the branches 133a to 133d.

Each set of branches 133a to 133d includes two longitudinal branches forming first and second storage electrodes 133a and 133b spaced apart from each other, and two oblique branches forming third and fourth storage electrodes 133c and 133d connected between the first and second storage electrodes 133a and 133b. The first storage electrode 133a has a free end portion having a projection and a fixed end portion that is connected to the storage electrode line 131. The third and fourth storage electrodes 133c and 133d extend approximately from a center of the first storage electrode 133a and upper and lower ends of the second storage electrode 133b, respectively. The storage electrode lines 131 may have various shapes and arrangements.

Each of the connections 133e is connected between a first storage electrode 133a of a set of storage electrodes 133a to 133d and a second storage electrode 133b of another set of storage electrodes 133a to 133d adjacent thereto.

The storage electrode lines 131 are supplied with a predetermined voltage such as a common voltage, which is applied to a common electrode 270 on the common electrode panel 200 of the LCD. Each storage electrode line 131 may include a pair of stems extending in the transverse direction.

The gate lines 121 and the storage electrode lines 131 are preferably made of an aluminum (Al) containing metal such as Al and an Al alloy, a silver (Ag) containing metal such as Ag and a Ag alloy, a copper (Cu) containing metal such as Cu and a Cu alloy, a molybdenum (Mo) containing metal such as Mo and a Mo alloy, chromium (Cr), titanium (Ti), or tantalum (Ta). The gate lines 121 and the storage electrode lines 131 may have a multi-layered structure including two films having different physical characteristics. One of the two films is preferably made of a low resistivity metal including an Al-containing metal, a Ag-containing metal, and a Cu-containing metal for reducing signal delay or voltage drop in the gate lines 121 and the storage electrode lines 131. The other film is preferably made of a material such as a Mo-containing metal, Cr, Ta, or Ti, which has good physical, chemical, and electrical contact characteristics with other materials such as indium tin oxide (ITO) or indium zinc oxide (IZO). Examples of the combination of the two films are a lower Cr film and an upper Al alloy film and a lower Al film and an upper Mo film. The gate line 121 and the storage electrode line 131 may be made of various metals or conductors.

The lateral sides of the gate lines 121 and the storage electrode lines 131 are inclined relative to a surface of the substrate, and the inclination angle thereof ranges from about 30 to 80 degrees.

A gate insulating layer 140 preferably made of silicon nitride (SiNx) is formed on the gate lines 121 and the storage electrode lines 131.

A plurality of semiconductor stripes 151 preferably made of hydrogenated amorphous silicon (abbreviated to “a-Si”) or polysilicon are formed on the gate insulating layer 140. Each semiconductor stripe 151 extends substantially in the longitudinal direction and has a plurality of projections 154 branched out toward the gate electrodes 124. The semiconductor stripes 151 have an increased width near the gate lines 121 and the storage electrode lines 131 such that the semiconductor stripes 151 cover areas of the gate lines 121 and the storage electrode lines 131.

A plurality of ohmic contact stripes and islands 161 and 165 preferably made of silicide or n+ hydrogenated a-Si heavily doped with an n-type impurity such as phosphorous are formed on the semiconductor stripes 151. Each ohmic contact stripe 161 has a plurality of projections 163. The projections 163 and the ohmic contact islands 165 are located in pairs on the projections 154 of the semiconductor stripes 151.

The lateral sides of the semiconductor stripes 151 and the ohmic contacts 161 and 165 are inclined relative to a surface of the substrate, and the inclination angles thereof are preferably in a range between about 30 to 80 degrees.

A plurality of data lines 171, a plurality of drain electrodes 175 separated from the data lines 171, and a plurality of isolated metal pieces 178 are formed on the ohmic contacts 161 and 165 and the gate insulating layer 140.

The data lines 171 for transmitting data voltages extend substantially in the longitudinal direction and cross the gate lines 121 at substantially right angles. The data lines 171 also intersect the storage electrode lines 131 and the connections 133e such that each data line 171 is disposed between the first and second storage electrodes 133a and 133b in adjacent sets of the branches 133a to 133d of the storage electrode lines 131. Each data line 171 includes an end portion 179 having a widened area for contact with another layer or an external device. A data driving circuit (not shown) for generating the data signals may be mounted on an FPC film (not shown), which may be attached to the substrate 110, directly mounted on the substrate 110, or integrated into the substrate 110. The data lines 171 may extend to be connected to a driving circuit integrated on the substrate 110. Each data line 171 includes a plurality of source electrodes 173 projecting toward the drain electrodes 175.

Each drain electrode 175 includes an end portion having a widened area for contact with another layer and another end portion disposed on a gate electrode 124 and partly enclosed by a source electrode 173.

A gate electrode 124, a source electrode 173, and a drain electrode 175 along with a projection 154 of a semiconductor stripe 151 form a TFT having a channel formed in the projection 154 disposed between the source electrode 173 and the drain electrode 175.

The metal pieces 178 are disposed on the gate lines 121 near the end portions of the storage electrodes 133a.

The data lines 171, the drain electrodes 175, and the metal pieces 178 are preferably made of a refractory metal such as Cr, Mo, Ti, Ta, or alloys thereof. They may also have a multilayered structure including a low-resistivity film (not shown) and a contact film (not shown). An example of the combination is a lower Mo film, an intermediate Al film, and an upper Mo film as well as the above-described combinations of a lower Cr film and an upper Al—Nd (neodymium) alloy film and a lower Al film and an upper Mo film. The data lines 171, the drain electrodes 175, and the metal pieces 178 may be made of various metals or conductors.

The storage electrode lines 131, the data lines 171 and the drain electrodes 175 have tapered lateral sides, and the inclination angles thereof range from about 30 to 80 degrees.

The ohmic contacts 161 and 165 are interposed only between the underlying semiconductor stripes 151 and the overlying data lines 171 and the overlying drain electrodes 175 thereon, and reduce the contact resistance there between. The semiconductor stripes 151 include a plurality of exposed portions, which are not covered with the data lines 171 and the drain electrodes 175, such as portions located between the source electrodes 173 and the drain electrodes 175. The semiconductor stripes 151 have first portions that are narrower than the data lines 171, and second portions near the gate lines 121 and the storage electrode lines 131 that are wider than the data lines 171 to smooth the profile of the surface, thereby substantially preventing the disconnection of the data lines 171. The semiconductor stripes 151 include exposed portions, which are not covered with the data conductors 171 and 175, such as portions located between the source electrodes 173 and the drain electrodes 175.

A passivation layer 180 is formed on the data lines 171, the drain electrodes 175, the metal pieces 178, and the exposed portions of the semiconductor stripes 151. The passivation layer 180 is preferably made of an inorganic insulator such as silicon nitride or silicon oxide, a photosensitive organic material having a good flatness characteristic, or a low dielectric insulating material having a dielectric constant lower than about 4.0 such as a-Si:C:O and a-Si:O:F formed by plasma enhanced chemical vapor deposition (PECVD). The passivation layer 180 may include a lower film of an inorganic insulator and an upper film of an organic insulator such that it takes the insulating characteristics of the organic insulator while substantially preventing the exposed portions of the semiconductor stripes 151 from being damaged by the organic insulator.

The passivation layer 180 has a plurality of contact holes 182 and 185 exposing the end portions 179 of the data lines 171 and the end portions of the drain electrodes 175, respectively. The passivation layer 180 and the gate insulating layer 140 have a plurality of contact holes 181 exposing the end portions 129 of the gate lines 171, a plurality of contact holes 183a exposing portions of the storage electrode lines 131 near the fixed end portions of the first storage electrodes 133a, and a plurality of contact holes 183b exposing the projections of the free end portions of the first storage electrodes 133a.

A plurality of pixel electrodes 191, a plurality of contact assistants 81 and 82, and a plurality of overpasses 83, which are preferably made of a transparent conductor such as ITO or IZO or a reflective conductor such as Ag or Al, are formed on the passivation layer 180.

The pixel electrodes 191 are physically and electrically connected to the drain electrodes 175 through the contact holes 185 such that the pixel electrodes 191 receive the data voltages from the drain electrodes 175.

The pixel electrodes 191 supplied with the data voltages generate electric fields in cooperation with the common electrode 270, which control the orientations of liquid crystal molecules in the liquid crystal layer 3.

A pixel electrode 191 and the common electrode 270 of the common electrode panel 200 form a liquid crystal capacitor, which stores applied voltages after turn-off of the TFT. A storage capacitor is connected in parallel to the liquid crystal capacitor, and is provided for enhancing the voltage storing capacity. The storage capacitors are implemented by overlapping the pixel electrodes 191 with the storage electrode lines 131 including the storage electrodes 133a to 133d.

Each pixel electrode 191 is chamfered at its left corner, wherein the chamfered edges of the pixel electrode 191 make an angle of about 45 degrees with the gate lines 121.

Each pixel electrode 191 has a lower cutout 92a, a center cutout 91, and an upper cutout 92b, which partition the pixel electrode 191 into a plurality of partitions. The cutouts 91 to 92b substantially have inversion symmetry with respect to an imaginary transverse line bisecting the pixel electrode 191.

The lower and upper cutouts 92a and 92b obliquely extend from a right edge of the pixel electrode 191 near an upper right corner approximately to a center of a left edge of the pixel electrode 191 and overlap the third and fourth storage electrodes 133c and 133d. The lower and upper cutouts 92a and 92b are disposed at lower and upper halves of the pixel electrode 191, respectively, which can be divided by the imaginary transverse line. The lower and upper cutouts 92a and 92b make an angle of about 45 degrees to the gate lines 121, and they extend substantially perpendicular to each other.

The center cutout 91 extends along the imaginary transverse line and has an inlet from the right edge of the pixel electrode 191, which has a pair of inclined edges substantially parallel to the lower cutout 92a and the upper cutout 92b, respectively.

The lower half of the pixel electrode 191 is partitioned into two lower partitions by the lower cutout 92a. The upper half of the pixel electrode 191 is partitioned into two upper partitions by the upper cutout 92b. The number of partitions or the number of cutouts may be varied depending on the design factors such as the size of pixels, the ratio of the transverse edges and the longitudinal edges of the pixel electrodes, the type and characteristics of the liquid crystal layer 3, and so on.

The contact assistants 81 and 82 are connected to the end portions 129 of the gate lines 121 and the end portions 179 of the data lines 171 through the contact holes 181 and 182, respectively. The contact assistants 81 and 82 protect the end portions 129 and 179 and complement the adhesion of the end portions 129 and 179 and external devices.

The overpasses 83 cross over the gate lines 121 and are connected to the exposed projection of the fixed end portions of the first storage electrodes 133a and the exposed portions of the storage electrode lines 131 through the contact holes 183b and 183a, respectively, which are disposed opposite each other with respect to the gate lines 121. The overpasses 83 overlap the metal pieces 178 and may be electrically connected to the metal pieces 178. The storage electrode lines 131 including the storage electrodes 133a to 133d along with the overpasses 83. The metal pieces 178 may be used for repairing defects in the gate lines 121, the data lines 171, or the TFTs.

The description of the common electrode panel 200 follows with reference to FIGS. 2 to 4.

A light blocking member 220, called a black matrix, for substantially preventing light leakage, is formed on an insulating substrate 210 made of a material such as transparent glass. The light blocking member 220 may include a plurality of openings 225 that face the pixel electrodes 191 and may have substantially the same planar shape as the pixel electrodes 191. The light blocking member 220 may include linear portions corresponding to the data lines 171 and the gate lines 121, and other portions corresponding to the TFTs.

A plurality of color filters 230 are formed on a surface the substrate 210 adjacent to the pixel electrodes 191. The color filters 230 are disposed substantially in the areas enclosed by the light blocking member 220. The color filters 230 may extend substantially along the longitudinal direction along the pixel electrodes 191. The color filters 230 may represent one of the primary colors such as red, green, and blue.

An overcoat 250 is formed on the color filters 230 and the light blocking member 220 for the overcoat 250 substantially prevents the color filters 230 from being exposed and provides a flat surface on the color filters 230 and the light blocking member 220. The overcoat 250 may be omitted.

A common electrode 270 preferably made of a transparent conductive material such as ITO and IZO is formed on the overcoat 250 and is thicker than the pixel electrode 191.

The common electrode 270 has a plurality of sets of cutouts 71 to 72b.

A set of cutouts 71 to 72b faces a pixel electrode 191, and includes a lower cutout 72a, a center cutout 71, and an upper cutout 72b. Each of the cutouts 71 to 72b is disposed between adjacent cutouts 91 to 92b of the pixel electrode 191 or between a cutout 92a or 92b and a chamfered edge of the pixel electrode 191. Each of the cutouts 71 to 72b has at least an oblique portion extending parallel to the lower cutout 92a or the upper cutout 92b of the pixel electrode 191. The distances between two adjacent cutouts 71 to 72b and 91 to 92b, the oblique portions thereof, the oblique edges thereof, and the chamfered edges of the pixel electrode 191, which are parallel to each other, are substantially the same. The cutouts 71 to 72b substantially have inversion symmetry with respect to the above-described transverse line bisecting the pixel electrode 191, and are wider than the cutouts 91 to 92b of the pixel electrode 191.

Each of the lower and upper cutouts 72a and 72b includes an oblique portion extending approximately from a left edge of the pixel electrode 191 to approximately a lower or upper edge of the pixel electrode 191, and transverse and longitudinal portions extending from respective ends of the oblique portion along edges of the pixel electrode 191, overlapping the edges of the pixel electrode 191, and making obtuse angles with the oblique portion.

The center cutout 71 includes a central transverse portion extending approximately from the left edge of the pixel electrode 191 along the third storage electrode 133c, a pair of oblique portions extending from an end of the central transverse portion approximately to a right edge of the pixel electrode and making obtuse angles with the central transverse portion, and a pair of terminal longitudinal portions extending from the ends of the respective oblique portions along the right edge of the pixel electrode 191, overlapping the right edge of the pixel electrode 191, and making obtuse angles with the respective oblique portions.

The number of the cutouts 71 to 72b may be varied depending on the design factors. The light blocking member 220 may also overlap the cutouts 71 to 72b to block the light leakage through the cutouts 71 to 72b.

Alignment layers 11 and 21 are coated on inner surfaces of the panels 100 and 200. Alignment layers 11 and 21 may be homeotropic. Polarizers 12 and 22 are provided on outer surfaces of the panels 100 and 200 such that their polarization axes may be crossed and one of the transmissive axes may be parallel to the gate lines 121. One of the polarizers may be omitted when the LCD is a reflective LCD.

The LCD may further include at least one retardation film (not shown) for compensating the retardation of the LC layer 3. The retardation film has birefringence and retards opposite to the LC layer 3. The retardation film may include a uniaxial or biaxial optical compensation film, and in particular, a negative uniaxial compensation film.

The LCD may further include a backlight unit (not shown) for supplying light to the LC layer 3 through the polarizers 12 and 22, the retardation film, and the panels 100 and 200.

It is preferable that the LC layer 3 has negative dielectric anisotropy and it is subjected to a vertical alignment such that the LC molecules in the LC layer 3 are aligned with their long axes substantially vertical to the surfaces of the panels 100 and 200 in the absence of an electric field.

Upon application of the common voltage to the common electrode 270 and a data voltage to the pixel electrodes 191, an electric field substantially perpendicular to the surfaces of the panels 100 and 200 is generated. The LC molecules tend to change their orientations in response to the electric field such that their long axes are substantially perpendicular to the field direction. The common electrode 270 and the pixel electrodes 191 are used as a field-generating electrode.

The cutouts 91 to 92b and 71 to 72b of the electrodes 191 and 270 and the edges of the pixel electrodes 191 distort the electric field to have a horizontal component that is substantially perpendicular to the edges of the cutouts 91 to 92b and 71 to 72b and the edges of the pixel electrodes 191. Accordingly, the LC molecules on each sub-area are tilted in a direction by the horizontal component and the azimuthal distribution of the tilt directions are localized to four directions, thereby increasing the viewing angle of the LCD.

At least one of the cutouts 91 to 92b and 71 to 72b can be substituted with protrusions (not shown) or depressions (not shown). The protrusions are preferably made of an organic or inorganic material and disposed on or under the field-generating electrodes 191 or 270.

The common electrode 270 is thicker than the pixel electrode 191. Because the sheet resistance of the common electrode 270 is decreased, the voltage variation of the common electrode 270 is decreased. The width of the cutouts 91 to 92b of the pixel electrode 191 is wider than that of the cutouts 71 to 72b of the common electrode 270. Therefore, the horizontal component of the electric field generated by the cutouts 71 to 72b of the common electrode 270 may be controlled to be substantially equal to that of the electric field generated by the cutouts 91 to 92b of the pixel electrodes 190.

When the pixel electrode 191 is thicker than the common electrode 270, if the width of the cutouts 91 to 92b of the pixel electrode 191 is substantially equal to that of the cutouts 71 to 72b of the common electrode 270, the horizontal component of the electric field generated by the cutouts 91 to 92b of the pixel electrodes 190 is larger than that of the electric field generated by the cutouts 71 to 72b of the common electrode 270.

The differences of the horizontal components between the common electrode 270 and the pixel electrodes 191 are increased according to the increasing of the thicknesses between the common electrode 270 and the pixel electrodes 191, wherein it is preferable that the differences of the widths between the cutouts 91 to 92b of the pixel electrodes 191 and 71 to 72b of the common electrode 270 are increased according to the increase of the thicknesses between the common electrode 270 and the pixel electrodes 191. The width of the cutouts 71 to 72b of the common electrode 270 is determined with the consideration of an optimized aperture ratio and the optimized horizontal components, and the width of the cutouts 91 to 92b of the pixel electrodes 191 is determined with consideration of the balance of horizontal components.

Various examples will be explained with reference to the drawings.

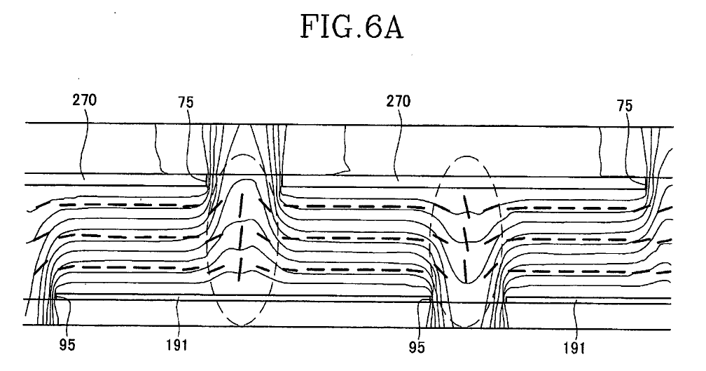

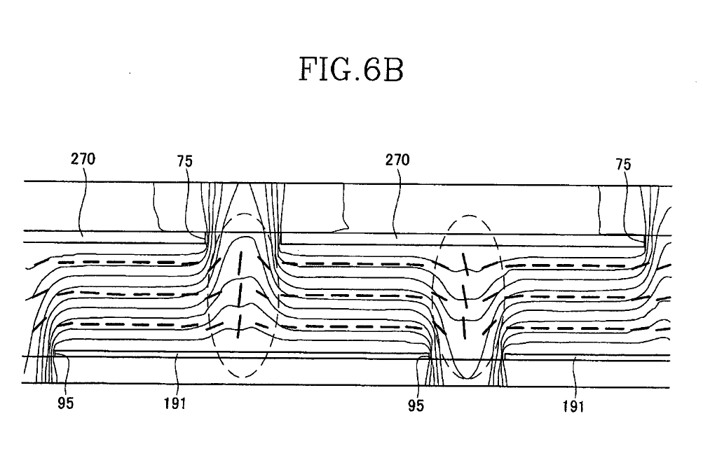

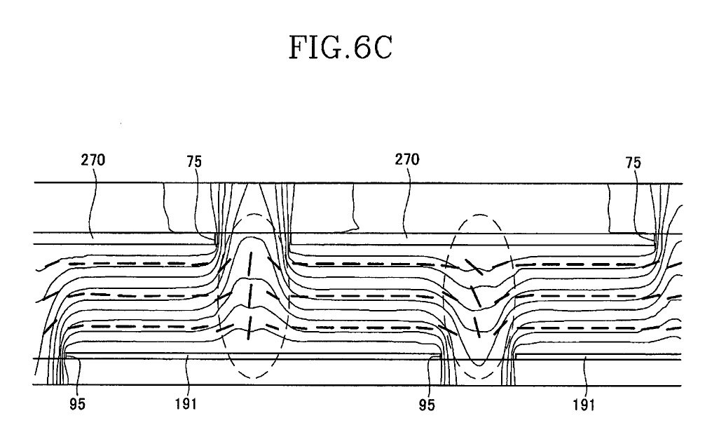

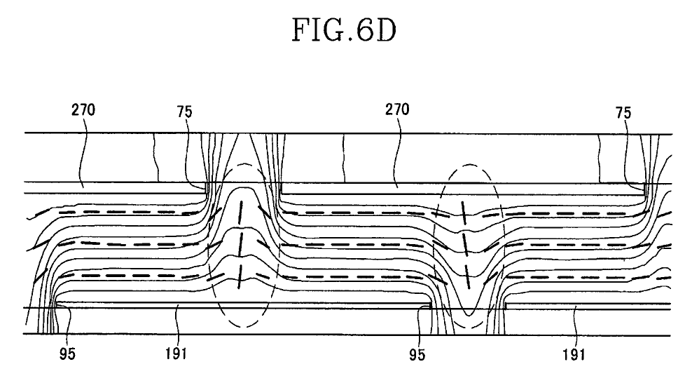

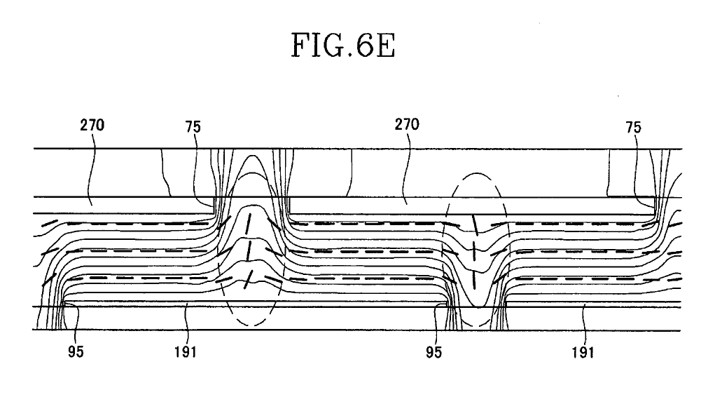

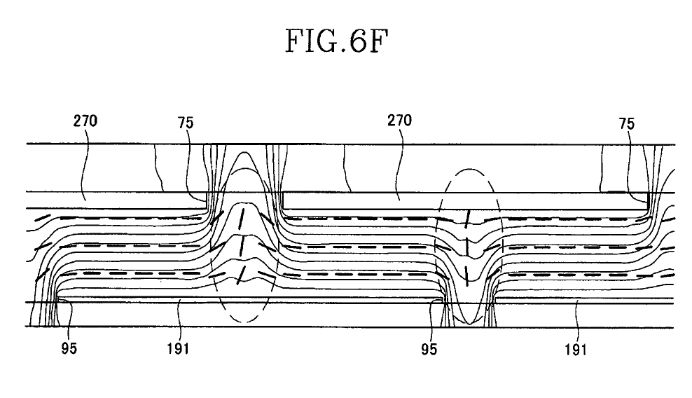

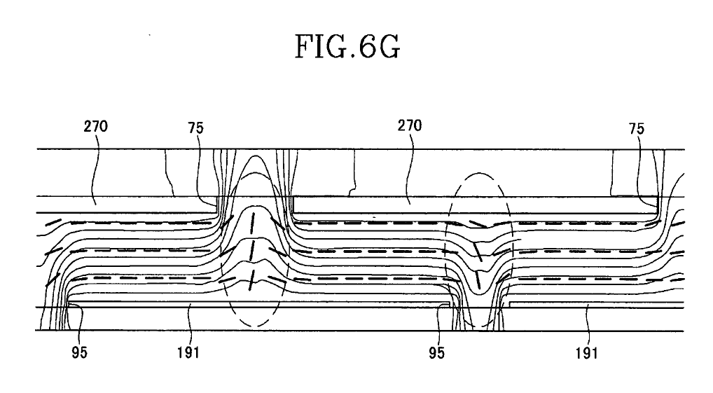

FIGS. 6A to 6G are views showing exemplary equipotential lines depending on the variety of widths of the cutouts in the LCDs according to an embodiment of the present invention.

The voltage difference between the pixel electrodes 191 and the common electrodes 270 is about 5V. The thickness of the common electrode 270 is twice the thickness of the pixel electrodes 191s in FIG. 6A to FIG. 6D, and the thickness of the common electrode 270 is three times the thickness of the pixel electrodes 191s in FIG. 6E to FIG. 6G

In FIG. 6A, the widths of the cutout 75 of the common electrode 270 and the cutout 95 of the pixel electrode 190 are 10 μm. As shown in FIG. 6A, the interval of the equipotential lines formed on the side of the cutout 95 of the pixel electrode 191 is narrower than that of the equipotential lines formed on the side of the cutout 75 of the common electrode 270. Accordingly, the horizontal component of the electric field generated by the cutout 95 of the pixel electrode 191 is larger than that of the electric field generated by the cutout 75 of the common electrode 270.

In FIGS. 6B to 6D, the width of the cutout 75 of the common electrode 270 is 10 μm, and the widths of the cutout 95 of the pixel electrode 190 are respectively 9 μm, 8 μm, and 7 μm.

The horizontal components of the electric fields generated by the cutout 75 of the common electrode 270 and the cutout 95 of the pixel electrode 191 still have differences, but the differences of the horizontal components of the electric fields are smaller than those of FIG. 6A. The horizontal components of the electric fields generated by the cutout 75 of the common electrode 270 and the cutout 95 of the pixel electrode 191 are substantially equal to each other in FIG. 6C. The horizontal components of the electric fields generated by the cutout 75 of the common electrode 270 are larger than those of the cutout 95 of the pixel electrode 191 in FIG. 6D, and the differences of the horizontal components of the electric fields are small.

In FIGS. 6E to 6G, the width of the cutout 75 of the common electrode 270 is 10 μm, and the widths of the cutout 95 of the pixel electrode 190 are respectively 8 μm, 7 μm, and 6 μm.

The horizontal components of the electric fields generated by the cutout 75 of the common electrode 270 and the cutout 95 of the pixel electrode 191 are substantially equal to each other, the horizontal components of the electric fields generated by the cutout 75 of the common electrode 270 is large in FIG. 6E, and the horizontal components of the electric fields generated by the cutout 95 of the pixel electrode 191 are large in FIG. 6F. The horizontal component of the electric fields generated by the cutout 75 of the common electrode 270 is larger in FIG. 6G.

When the common electrode 270 is thicker than the pixel electrode by 1.5 to 2.0 times, it is preferable that the width of the cutouts 91 to 92b of the pixel electrode 191 is in the range of about 60 to 90 percent of the width of the cutouts 71 to 72b of the common electrode 270 to maintain the aperture ratio and the horizontal components of the electric field. In particularly, the common electrode 270 is twice the thickness of the pixel electrode, and it is preferable that the width of the cutouts 91 to 92b of the pixel electrode 191 is in the range of about 70 to 90 percent of the width of the cutouts 71 to 72b of the common electrode 270. The common electrode 270 is thicker than the pixel electrode by three times, and it is preferable that the width of the cutouts 91 to 92b of the pixel electrode 191 is in the range of about 60 to 90 percent of the width of the cutouts 71 to 72b of the common electrode 270.

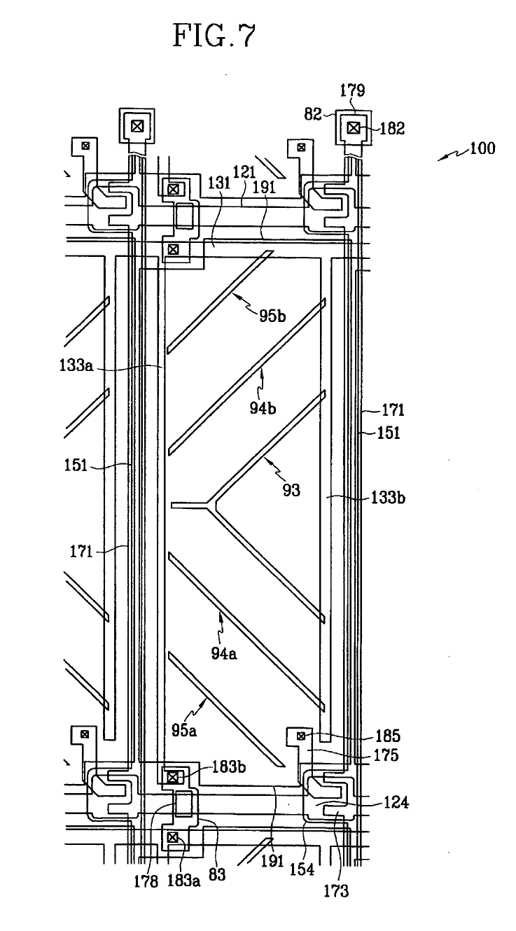

An LCD according to another embodiment of the present invention will now be described in detail with reference to FIGS. 7 to 10.

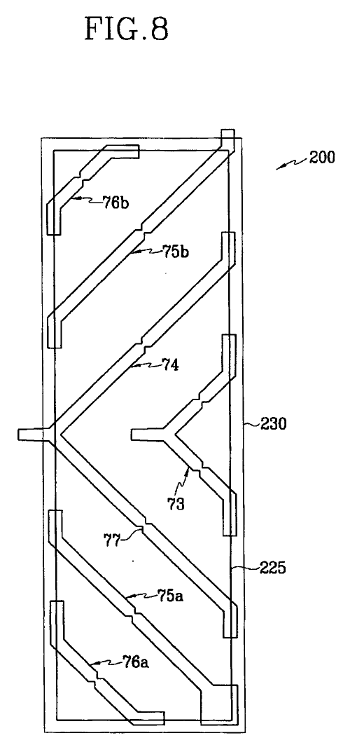

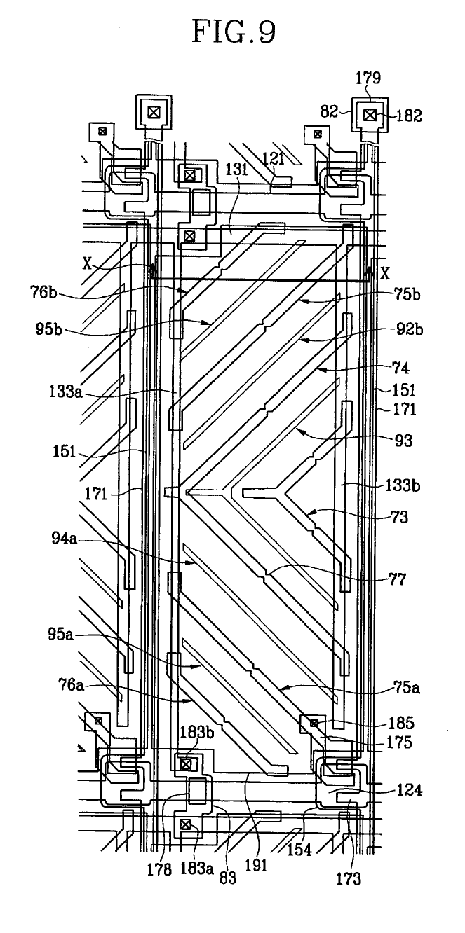

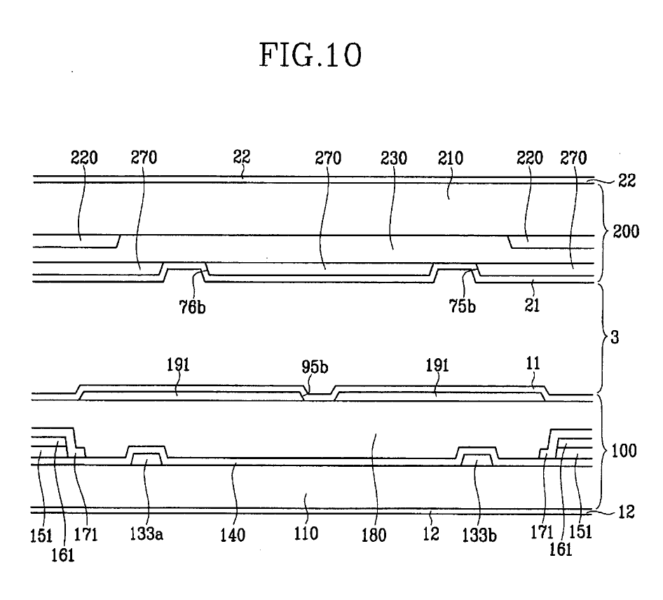

FIG. 7 is a layout view of a TFT array panel for an LCD according to an embodiment of the present invention, FIG. 8 is a layout view of a common electrode panel for an LCD according to an embodiment of the present invention, FIG. 9 is a layout view of an LCD including the TFT array panel shown in FIG. 7 and the common electrode panel shown in FIG. 8, and FIG. 10 is a sectional view of the LCD shown in FIG. 9 taken along the line X-X.

Referring to FIGS. 7 to 10, an LCD according to an embodiment includes a TFT array panel 100, a common electrode panel 200, an LC layer 3 interposed between the panels 100 and 200, and a pair of polarizers 12 and 22 attached on outer surfaces of the panels 100 and 200.

Layered structures of the panels 100 and 200 are substantially the same as those shown in FIGS. 1 to 5.

Regarding the TFT array panel 100, a plurality of gate lines 121 including gate electrodes 124 and end portions 129 and a plurality of storage electrode lines 131 are formed on a substrate 110, and a gate insulating layer 140, a plurality of semiconductor stripes 151 including projections 154, and a plurality of ohmic contact stripes 161 including projections 163 and a plurality of ohmic contact islands 165 are sequentially formed thereon. A plurality of data lines 171 including source electrodes 173 and end portions 179, a plurality of drain electrodes 175, and a plurality of isolated metal pieces 178 are formed on the ohmic contacts 161 and 165, and a passivation layer 180 is formed thereon. A plurality of contact holes 181, 182, 183a, 183b, and 185 are provided at the passivation layer 180 and the gate insulating layer 140. A plurality of pixel electrodes 191, a plurality of contact assistants 81 and 82, and a plurality of overpasses 83 are formed on the passivation layer 180, and an alignment layer 11 is coated thereon.

Regarding the common electrode panel 200, a light blocking member 220, a plurality of color filters 230, a common electrode 270, and an alignment layer 21 are formed on an insulating substrate 210.

The storage electrode lines 131 each include a stem extending substantially parallel to the gate lines 121 and a plurality of pairs of storage electrodes 133a and 133b branched from the stems. Each of the storage electrodes 133a and 133b has a fixed end portion connected to the stem and a free end portion disposed opposite thereto.

Each pixel electrode 191 has lower cutouts 94a and 95a, a center cutout 93, and upper cutouts 94b and 95b, which partition the pixel electrode 191 into a plurality of partitions. The cutouts 93 to 95b substantially have inversion symmetry with respect to an imaginary transverse line bisecting the pixel electrode 191.

The lower and upper cutouts 94a to 95b obliquely extend from a right edge of the pixel electrode 191 near an upper right corner approximately to a center of a left edge of the pixel electrode 191. The lower and upper cutouts 94a to 95b are disposed at lower and upper halves of the pixel electrode 191, respectively, which can be divided by the imaginary transverse line. The lower and upper cutouts 94a to 95b make an angle of about 45 degrees with the gate lines 121, and they extend substantially perpendicular to each other.

The center cutout 93 includes a central transverse portion extending approximately from the left edge of the pixel electrode 191 and a pair of oblique portions extending from an end of the central transverse portion approximately to a right edge of the pixel electrode and making obtuse angles with the central transverse portion.

A common electrode 270 has a plurality of sets of cutouts 73, 74, 75a, 75b, 76a, and 76b.

A set of cutouts 73 to 76b faces a pixel electrode 190 and includes center cutouts 73 and 74, lower cutout 75a and 76a, and upper cutouts 75b and 76b.

Each of the lower and upper cutouts 76a and 76b includes an oblique portion and a pair of transverse and longitudinal portions. The oblique portion extends approximately from a lower edge or an upper edge of the pixel electrode 191 to approximately a left edge of the pixel electrode 191. The transverse and longitudinal portions extend from respective ends of the oblique portion along edges of the pixel electrode 191, overlapping the edges of the pixel electrode 191, and making obtuse angles with the oblique portion.

Each of the lower and upper cutouts 75a and 75b includes an oblique portion, and longitudinal or extension portions. The oblique portion extends approximately from a left edge of the pixel electrode 191 to approximately a right corner of the pixel electrode 191, and the longitudinal or extension portions are disposed near the right corner of the pixel electrode 191. The end of the oblique portion is connected to the longitudinal portions, and the longitudinal portion overlaps the edges of the pixel electrode 191 and makes obtuse angles with the oblique portion.

Each of the center cutouts 73 and 74 includes a central transverse portion, a pair of oblique portions, and a pair of terminal longitudinal portions. The central transverse portion is disposed near the left edge or a center of the pixel electrode 191 and extends on the right side along the transverse center line of the pixel electrode 191. The oblique portions extend from an end of the central transverse portion or approximately from a center of the right edge of the pixel electrode 191, approximately to the left edge of the pixel electrode 191. The oblique portions make oblique angles with the central transverse portion. The terminal longitudinal portions extend from the ends of the respective oblique portions along the left edge of the pixel electrode 190, overlapping the left edge of the pixel electrode 190, and making obtuse angles with the respective oblique portions.

The cutouts 73, 74, 75a, 75b, 76a, and 76b include notches 77 disposed in the center position of the oblique portions. The notches 77 in the cutouts 73 to 76b determine the tilt directions of the LC molecules on the cutouts 73 to 76b and they may be provided at the cutouts 93 to 95b and may have various shapes and arrangements. The notches 77 may substitute for a plurality of bridges passing the cutouts 73 to 76b, and may be omitted.

As above-described, the widths of the cutouts of the pixel electrode 191 are wider than that of the cutouts of the common electrode 270. The above-described features of the LCD shown in FIGS. 1 to 5 may be appropriate to the LCD shown in FIGS. 7 to 10.

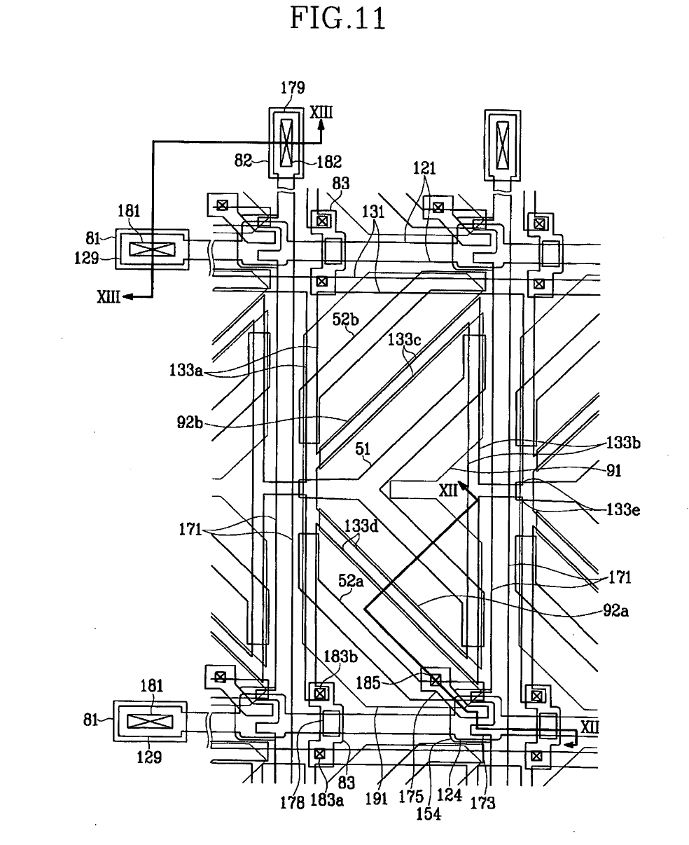

An LCD according to another embodiment of the present invention will be described in detail with reference to FIGS. 11 to 13.

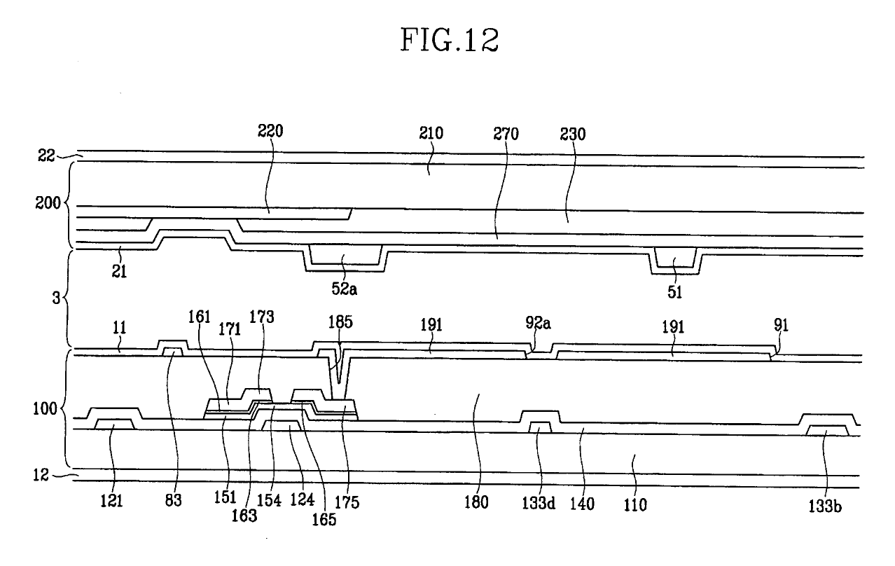

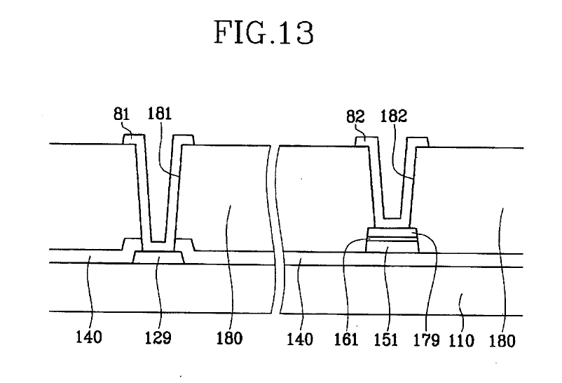

FIG. 11 is a layout view of an LCD according to another embodiment of the present invention, and FIGS. 12 and 13 are sectional views of the LCD shown in FIG. 11 taken along the lines XII-XII and XIII-XIII, respectively.

Referring to FIGS. 11 to 13, an LCD includes a TFT array panel 100, a common electrode panel 200, an LC layer 3 interposed between the panels 100 and 200, and a pair of polarizers 12 and 22 attached on outer surfaces of the panels 100 and 200.

Layered structures of the panels 100 and 200 according to an embodiment are substantially the same as those shown in FIGS. 1 to 5.

Regarding the TFT array panel 100, a plurality of gate lines 121 including gate electrodes 124 and end portions 129 and a plurality of storage electrode lines 131 including a set of storage electrodes 133a to 133d are formed on a substrate 110, and a gate insulating layer 140, a plurality of semiconductor stripes 151 including projections 154, and a plurality of ohmic contact stripes 161 including projections 163 and a plurality of ohmic contact islands 165 are sequentially formed thereon. A plurality of data lines 171 including source electrodes 173 and end portions 179, a plurality of drain electrodes 175, and a plurality of isolated metal pieces 178 are formed on the ohmic contacts 161 and 165, and a passivation layer 180 is formed thereon. A plurality of contact holes 181, 182, 183a, 183b, and 185 are provided at the passivation layer 180 and the gate insulating layer 140. A plurality of pixel electrodes 191, a plurality of contact assistants 81 and 82, and a plurality of overpasses 83 are formed on the passivation layer 180, and an alignment layer 11 is coated thereon.

Regarding the common electrode panel 200, a light blocking member 220 having a plurality of openings 225, a plurality of color filters 230, a common electrode 270, and an alignment layer 21 are formed on an insulating substrate 210.

The common electrode panel 200 includes a plurality of sets of protrusions 51, 52a, and 53b disposed on the common electrode 270 as a substitution for the cutout of the common electrode 270. The protrusions 51 to 52b are preferably made of an organic insulator. Each of the protrusions 51 to 52b has principal edges parallel to edges of the cutouts 91 to 92b and the chamfered left edges of the pixel electrode 191 and facing the cutouts 91 to 92b or the chamfered edges of the pixel electrode 191.

The common electrode 270 has no cutout and the overcoat may be omitted. Omission of the overcoat is optional.

The alignment layer 21 is protruded depending on the protrusions 51 to 52b. When the alignment layer 21 is a homogeneous alignment layer, the LC molecules in the LC layer 3 are aligned such that their long axes are substantially vertical to the surfaces of the alignment layer 3. Accordingly, the LC molecules on the protrusions 51 to 52b are declined to the surface of the insulating substrate 210. The dielectric constant of the protrusions 51 to 52b is different from that of the liquid crystal layer 3, wherein the protrusions 51 to 52b distort the electric field formed between the pixel electrode 191 and the common electrode 270 such that the horizontal component of the electric fields is formed.

The protrusions 51 to 52b are disposed at substantially the same positions as the cutouts 71 to 72b of FIGS. 1 to 5, and the set of protrusions 51 to 52b face the pixel electrode 191. The protrusions 51 to 52b include a lower protrusion 52a, a center protrusion 51, and an upper protrusion 52b.

The cutouts 91 to 92b of the pixel electrode 191 and the protrusions 51 to 52b and the edges of the pixel electrodes 191 distort the electric field to have a horizontal component that is substantially perpendicular to the edges of the cutouts 91 to 92b and the protrusions 51 to 52b, and to the edges of the pixel electrodes 191. Accordingly, the LC molecules on each sub-area are tilted in a direction by the horizontal component and the azimuthal distribution of the tilt directions are localized to four directions, thereby increasing the viewing angle of the LCD.

The protrusions 51 to 52b may be disposed under the common electrode 270.

Alignment layers 11 and 21 are coated on inner surfaces of the panels 100 and 200. Alignment layers 11 and 21 may be homeotropic. Polarizers 12 and 22 are provided on outer surfaces of the panels 100 and 200.

According to an embodiment of the present invention, the common electrode 270 is thicker than the pixel electrode 191, and the width of the cutouts 91 to 92b of the pixel electrodes 191 are narrower than the width of the protrusions 51 to 52b on the common electrode 270.

The above-described features of the LCD shown in FIGS. 1 to 5 may be appropriate to the LCD shown in FIGS. 11 to 13.

The widths of the cutouts of the thin field-generating electrodes are narrower than that of the cutouts of the thick field-generating electrodes. Accordingly, the horizontal components of the electric fields generated by the cutouts of the common electrode and the pixel electrodes may be substantially equal to each other such that the aperture ratio may be maximized.

While the present invention has been described in detail with reference to preferred embodiments, those skilled in the art will appreciate that various modifications and substitutions can be made thereto without departing from the spirit and scope of the present invention.

What is claimed is:

1. A liquid crystal display panel, comprising:
a first substrate;
a plurality of first field-generating electrodes formed on the first substrate and having a first cutout;
a second substrate facing the first substrate;
a plurality of second field-generating electrodes formed on the second substrate and having a second cutout; and
a liquid crystal layer formed between the first and second substrates,
wherein the second field-generating electrodes are thicker than the first field-generating electrodes, and a width of the first cutout is in the range of about 50 to 90% of a width of the second cutout.

2. The liquid crystal display of claim 1, wherein the thickness of the second field-generating electrode is about 1.5 to 3 times the thickness of the first field-generating electrode.

3. The liquid crystal display of claim 1, wherein the first and second cutouts are alternately arranged.

4. The liquid crystal display of claim 3, wherein the second cutout comprises a notch.

5. The liquid crystal display of claim 1, further comprising:
a plurality of gate lines and a plurality of data lines formed on the first substrate; and
a plurality of thin film transistors electrically connected to the first field-generating electrode, the gate line, and the data line.

6. The liquid crystal display of claim 1, wherein the thin film transistor comprises:
a gate electrode electrically connected to the gate line;
a gate insulating layer covering the gate electrode;
a semiconductor formed on the gate insulating layer; and
a source and a drain electrodes formed the semiconductor.

7. The liquid crystal display of claim 1, further comprising a light blocking member formed on the second insulating substrate.

8. The liquid crystal display of claim 1, further comprising a plurality of color filters formed the second insulating substrate.

9. A liquid crystal display panel, comprising:
a first substrate;
a gate line and a data line formed on the first substrate;
a thin film transistor electrically connected to the gate line and the data line;
a pixel electrode electrically connected to the thin film transistor and having a first cutout;
a second substrate facing the first substrate;
a color filter formed on the second substrate;
a common electrode formed on the second substrate and having a second cutout; and
a liquid crystal formed between the first and second substrates,
wherein a thickness of the common electrode is about 1.5 to 3 times a thickness of the pixel electrode, and a width of the first cutout is in the range of about 50 to 90% of a width of the second cutout.

10. The liquid crystal display of claim 9, wherein the first and second cutouts are alternately arranged.

11. The liquid crystal display of claim 9, wherein the second cutout comprises a notch.

12. A liquid crystal display panel, comprising:
a first substrate;
a gate line and a data line formed on the first substrate;
a thin film transistor electrically connected to the gate line and the data line;
a pixel electrode electrically connected to the thin film transistor and having a cutout;
a second substrate facing the first substrate;
a color filter formed on the second substrate;
a common electrode formed on the second substrate;
a protrusion formed on the common electrode; and
a liquid crystal formed between the first and second substrates,
wherein the common electrode is thicker than the pixel electrode, and a width of the cutout is in the range of about 50 to 90% of a width of the protrusion.

13. The liquid crystal display of claim 12, wherein the thickness of the common electrode is about 1.5 to 3 times the thickness of the pixel electrode.

14. The liquid crystal display of claim 12, wherein the cutout and the protrusion are alternately arranged.

15. The liquid crystal display of claim 12, wherein the protrusion is made of an organic insulating material.
